(19) United States
(12) Patent Application Publication
(10) Pub. No.: US 2021/0232919 A1
(43) Pub. Date: Jul. 29, 2021

(54) MODULAR NETWORKS WITH DYNAMIC ROUTING FOR MULTI-TASK RECURRENT MODULES

(71) Applicant: NEC Laboratories America, Inc., Princeton, NJ (US)

(72) Inventors: Wei Cheng, Princeton Junction, NJ (US); Haifeng Chen, West Windsor, NJ (US); Jingchao Ni, Princeton, NJ (US); Dongkuan Xu, State College, PA (US)

(21) Appl. No.: 17/158,483

(22) Filed: Jan. 26, 2021

Related U.S. Application Data
(60) Provisional application No. 62/967,067, filed on Jan. 29, 2020.

(51) Int. Cl. G06N 3/08; G06F 9/48

(52) U.S. Cl. CPC G06N 3/08; G06F 9/4881

(57) ABSTRACT

Methods and systems for training a neural network model include training a modular neural network model, which has a shared encoder and one or more task-specific decoders, including training one or more policy networks that control connections between the shared encoder and the one or more task-specific decoders in accordance with multiple tasks. A multitask neural network model is trained for the multiple tasks, with an output of the modular neural network model and the multitask neural network model being combined to form a final output.

This application claims priority to U.S. Patent Application Ser. No. 62/967,067, filed on Jan. 29, 2020, incorporated herein by reference in its entirety.

### BACKGROUND

### Technical Field

The present invention relates to machine learning models, and, more particularly, to multi-task learning models that can handle multiple sequence processing tasks

### Description of the Related Art

Deep learning models with recurrent architectures are used in many sequence process tasks. However, while progress has been made on jointly learning multiple tasks, which may help to reduce the risk of over-fitting to one task and to save computation costs by sharing model architectures and low-level representations, existing approaches are not flexible enough to learn dynamic relationships and do not generalize well when generalization would need systematic compositional skills.

### SUMMARY

A method for training a neural network model includes training a modular neural network model, which has a shared encoder and one or more task-specific decoders, including training one or more policy networks that control connections between the shared encoder and the one or more task-specific decoders in accordance with multiple tasks. A multitask neural network model is trained for the multiple tasks, with an output of the modular neural network model and the multitask neural network model being combined to form a final output.

A system for training a neural network includes a hardware processor and a memory. The memory stores computer program code, which, when executed by the hardware processor, implements a multitask neural network model, a modular neural network model, a combiner, and a model trainer. The modular neural network model has a shared encoder, one or more task-specific decoders, and one or more policy networks that control connections between the shared encoder and the one or more task-specific decoders in accordance with multiple tasks. The combiner combines an output of the multitask neural network model to form a final output. The model trainer trains the modular neural network model, including training the one or more policy networks, and that trains the multitask neural network model for the multiple tasks.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram of a neural network model that handles multiple tasks, including a modular model that includes a shared encoder and task-specific decoders, in accordance with an embodiment of the present invention;

FIG. 2 is a block diagram of a shared encoder in a modular model that includes multiple sub-encoders with controllable connection weights between them, in accordance with an embodiment of the present invention;

FIG. 3 is a block diagram of a task-specific decoder in a modular model that includes multiple sub-encoders with controllable connection weights to sub-encoders of a shared encoder, in accordance with an embodiment of the present invention;

FIG. 4 is a block/flow diagram of a method of training and using a multitask neural network model, in accordance with an embodiment of the present invention;

FIG. 5 is a block diagram of a multitask machine learning system, in accordance with an embodiment of the present invention;

FIG. 6 is a high-level neural network architecture that can be used to implement a multitask neural network model, in accordance with an embodiment of the present invention; and

FIG. 7 is a diagram of a functional magnetic resonance imaging (fMRI) system that produces fMRI data from various regions of the brain, suitable for use in multiple different tasks, in accordance with an embodiment of the present invention.

### DETAILED DESCRIPTION OF PREFERRED EMBODIMENTS

A modular neural network model may be implemented with dynamic routing to learn task relationships dynamically and explicitly, with compositional generalization ability. The model may include a shared encoder, to store the knowledge shared by related tasks, and multiple decoders, to extract task-specific knowledge. The decoder outputs may be concatenated with the original hidden representation of each task to form a new task representation. This approach can be used in any multi-task recurrent model, where task relationships can be beneficial to the performance.

In particular, the encoder may be modularized into multiple layers of sub-networks, and each task-specific decoder may include several sub-decoders. By learning the connections between the sub-networks of the encoder and the sub-decoders, a model can selectively activate parts of the encoder for a task, with differing degrees of parameter sharing for tasks with different degrees of relatedness.

These connections between sub-networks may be learned by decision polices, sampled from discrete distributions that are indirectly parameterized by the output of policy networks. The policy networks determine whether to connect or disconnect a route between two sub-networks, on a per-instance basis. Differentiable binary routers may be used to train the policy networks.

A multi-task model is flexible by design, and may be used in a variety of different applications. In one example, different tasks may be related to functional magnetic resonance imaging (fMRI) data. This information may be used to analyze the relationship between brain connectivity and human behavior. For example, a person may complete various tasks while being scanned by an fMRI machine, with activity in their brain being imaged.

An fMRI task may be defined as a multi-class classification task of time series, at time steps t. Different brain regions may be related to, e.g., cognitive and sensory systems. In various tasks, the different regions may have different degrees of activity, in accordance with whether the task demands more cognitive or sensory effort. In this example, the multi-task model can handle various such tasks, automatically restructuring in accordance with the data that is being supplied. A self-organizing multi-task model can accommodate many such tasks, without the need for retraining.

In another exemplary application, part-of-speech (POS) tagging can be performed on code-switched sentences, where the words are from two languages. Code-switching may be found in multilingual contexts, such as in social media. Given an input sentence, where words are from multiple languages, a label sequence may be predicted for the POS of the words.

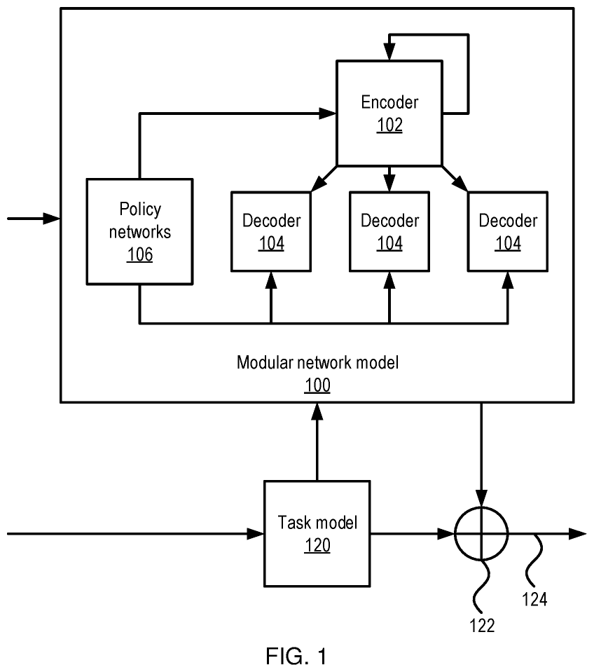

Referring now to FIG. 1, a high-level view of a machine learning model is shown. The model includes a modular network model 100 and a multitask model 120, both of which receive a given input. The multitask model 120 may be any appropriate model that is designed to handle multiple tasks, for example a preexisting model that may be enhanced by the use of the modular network model 100. The modular network model 100 may include an encoder 102 that is trained across multiple different tasks. The output of the encoder 102 is provided to any of several decoders 104, each of which is trained to perform a specific task. The output of the task-specific decoders 104 may be combined 122 with a hidden representation output of the multitask model 120 to generate a final output 124.

The shared encoder 102 may be formed, as described in greater detail below, as a set of generalizable sub-networks, which may be rearranged for particular tasks. The encoder 102 may have in layers, with each layer [symbol] ∈{1, 2, . . . , m} having [symbol] sub-networks. If xₜ is the input data at a timestep t, and the overall system of interest may be divided into k small subsystems, then k recurrent cells may be used to model the subsystems, each with its own independent dynamics. The form of the cells may be denoted by Cᵢ, and may be implemented as, e.g., a long-short term memory. A hidden state h_{t,i} after a cell Cᵢ is applied may be expressed as h_{t,i}=LSTMᵢ(h_{t-1,i},xₜ;θᵢ).

For each sub-network i in layer [symbol] of the encoder 102, there may be [symbol] policy networks 106. Each policy network 106, represented herein as [symbol] , estimates a decision vector α_{t,ij}∈ [symbol] ² for every sub-network j in the layer [symbol] +1 at the time step t, giving the output u_{t,i} of the sub-network I at the time t: { [symbol] :u_{t,i}→α_{t,ij}|i∈{1, . . . , [symbol] }, j∈{1, . . . , [symbol] }}. Given α_{t,ij}, a straight-through router may be used to learn a decision policy [symbol] (α_{t,ij}), which may estimate a binary decision value ζ_{t,ij}∈{0,1}, indicating whether to connect (e.g., ζ_{t,ij}=1) or disconnect (e.g., ζ_{t,ij}=0) the route between sub-networks i and j at a time step t: { [symbol] :α_{t,ij}→ζ_{t,ij}|i∈{1, . . . , [symbol] }, j∈{1, . . . , [symbol] }}. The policy networks 106 may further be informed by the hidden representation of the task model 120. The hidden representations may be the inputs of the policy networks, for example to learn α_{t,ij} The learning of β is similar.

Each sub-network j in layer [symbol] +1 receives a list of [symbol] tuples of features from the sub-networks in layer [symbol] , where tuple (u_{t,ij},ζ_{t,ij}) is the output of sub-network i in layer [symbol] . The input of sub-network j in layer [symbol] +1 may be calculated as:

$${v}_{t , j} = {\sum }_{i = 1}^{{n}_{ℓ}} \frac{{ζ}_{t , ij}}{{\sum }_{{i}^{′} = 1}^{{n}_{ℓ}} {ζ}_{t , {i}^{′} j}}$$

and the output of the sub-network j in layer [symbol] +1 may be calculated as:

u′_{t,j}=MLP(v_{(t,j)})

Each task-specific decoder 104 may be represented as [symbol] , having sub-decoders [symbol] that are used to extract information from layer [symbol] of the encoder 102. The sub-decoder [symbol] is connected to specific sub-networks of layer [symbol] by policy networks 106. For sub-decoder [symbol] each of [symbol] policy networks 106 estimates a decision vector β_{t,i}^{k}∈ [symbol] for every sub-network i in layer [symbol] at time step t, given the output u_{t.i}: { [symbol] :u_{t,i}→β_{t,i}^{k}|i ∈{1, . . . , [symbol] }}. Given β_{t,i}^{k}, a router may be used to learn a policy [symbol] (β_{t,i}^{k}), which estimates a binary decision value \hat{ξ}_{t,i}^{k}∈{0,1}: { [symbol] : β_{t,i}^{k}→\hat{ξ}_{t,i}^{k}|∈{1, . . . , [symbol] }}.

Sub-decoder [symbol] receives a list of [symbol] tuples of features from layer [symbol] of the encoder 102, where tuple (u_{t,i},\hat{ξ}_{t,ij}) is the output of the sub-network i in layer [symbol] . The input of sub-network j in layer [symbol] +1 may be calculated as:

$${\hat{v}}_{t , j} = {\sum }_{i = 1}^{{n}_{ℓ}} \frac{{\hat{ζ}}_{t , ij}}{{\sum }_{{i}^{′} = 1}^{{n}_{ℓ}} {\hat{ζ}}_{t , {i}^{′} j}}$$

and the output of the sub-network j in layer [symbol] +1 may be calculated as:

û′_{t,j}=MLP(\hat{v}_{(t,j)})

To consider the hierarchical structure of the encoder, the output of each sub-decoder [symbol] may be concatenated to construct the output of a decoder 104 as [symbol] =[ûₜ^{k,1}⊕ . . . ⊕ûₜ^{k,m}].

The role of policy networks 106 is to estimate the decision vector α={α₀,α₁}(β={β₀,β₁})∈ [symbol] ², which is further fed into the routers to make binary connection decisions. The form of policy networks 106 is flexible, and multilayer perceptrons (MLPs) may be used for the connection decisions in the shared encoder 102. The policy networks 106 may therefore be represented as α= [symbol] (u)=MLP(u). Policy networks 106 may be jointly trained with other parts of the model.

MLPs may also be used as the policy networks 106 for connection decisions between the sub-networks of the encoder 102 and the sub-decoders. If there is an original representation rₖ for a task k, the policy network 106 in this case may be represented as β= [symbol] (u)=MLP(u⊕Wₖrₖ), where Wₖ is a transformation matrix. If there is no rₖ, then the policy network 106 may be defined as β=MLP(u).

Given a two-dimensional output of a policy network 106, such as α={α₀, α₁}, a router may be applied to learn a decision policy that estimates a binary decision value ζ. The policy [symbol] (α) may be interpreted as a binarization function of the decision scores {α₀, α₁}, and each value in the pair of the binary outcomes is the complement of the other. The binarization function may be implemented by selecting the position with a maximum value of {α₀, α₁}, but this approach may be non-differentiable and deterministic. This may be addressed by adding Gumbel-Softmax sampling to draw samples from a discrete categorical distribution with class probabilities.

There may be two categories of policy decisions: connect and disconnect. The outputs {α₀, α₁} of the policy network 106 represent the log probabilities {log(p₀), log(p₁)} of the two classes. Based on Gumbel-Softmax sampling, samples may be drawn from a Bernoulli distribution that is parameterized by class probabilities {p₀, p₀}, for example by drawing samples {g₀, g₀} from a Gumbel distribution described as:

g=−log(−log(x))˜Gumbel

where x˜Uniform(0,1). The discrete sample may be produced by adding g to introduce stochasticity:

$$z = arg {max}_{i} [ {α}_{i} + {g}_{i} ] , \\ i ∈ \{ 0 , 1 \}$$

The argmax operation is non-differentiable, but softmax may be used as a continuous differentiable approximation to it, to produce a two-dimensional vector μ:

$${μ}_{i} = \frac{{e}^{\frac{( {α}_{i} + {g}_{i} )}{τ}}}{{\sum }_{\hat{ι} = 0}^{1} {e}^{\frac{( {α}_{\hat{ι}} + {g}_{\hat{ι}} )}{τ}}} , \\ i ∈ \{ 0 , 1 \}$$

where τ is a parameter to control discreteness. The function argmax may therefore be used to make the binary connection decision on the forward pass of processing, while being approximated with softmax on the backward pass.

Sparsity constraints may be used on the connection decision values ζ_{t,ij}, to prevent every pair of sub-networks in the encoder 102 from being connected. This coarse-grained network pruning benefits the specialization of sub-networks. The sparsity constraint may also be added on connection decision values \hat{ζ}_{t,i}^{k}, which helps the task-specific decoders avoid focusing on every sub-network of the encoder 102.

Two penalty terms may be added into the objective function of a multi-task recurrent model, λ₁R₁(ζ) and λ₂R₂(\hat{ζ}) The penalty terms represent penalties for connecting sub-networks in the encoder 102, and for connecting between decoders 104 and the sub-networks of the encoder 102. The penalty terms may be defined as:

λ₁R₁(ζ)=λ₁ReLU((Σζ_{t,ij})−γ₁C₁)

λ₂R₂(ζ)=λ₂ReLU((Σ\hat{ζ}_{t,ij})−γ₂C₂)

where λ and γ are hyper-parameters, C₁ is the number of all possible connections between sub-networks in the encoder 102, and C₂ is the number of all possible connections between the sub-networks of the encoders 102 and the sub-decoders of the decoders 104. The hyper-parameter γ represents the proportion of the connections that are not being penalized. Intuitively, each connection above the threshold λ₁C₁ or γ₂ C₂ may be penalized.

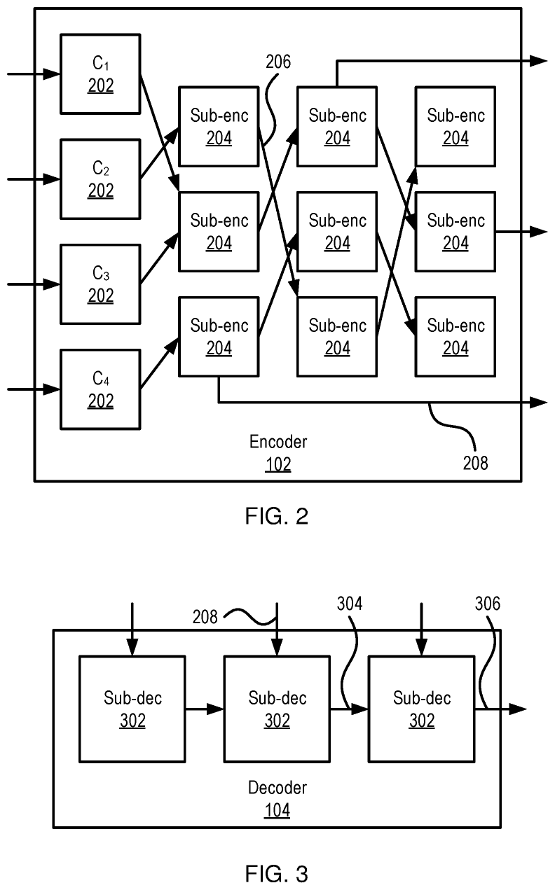

Referring now to FIG. 2, additional detail is shown on the shared encoder 102. A layer of input neurons 202 accept an input vector. Notably, this input may be recurrent, being based on the output of the encoder 102 at a previous time step, or may include a fresh vector. A number of sub-encoders 204 further process the data.

The connections 206 between these sub-encoders are determined by the policy networks 106. These connections 206 are connected or disconnected based on the determinations of the policy networks 106, in accordance with a task being performed. The policy networks 106, being jointly trained with the encoder 102 and the decoders 106, detect the task being performed and set the connections 206 accordingly.

In addition to the connections 206 between the sub-encoders 204, also shown are connections 208 between particular sub-encoders 204 and the sub-networks of the decoders 104. These connections 208 are also set by the policy networks 106, in accordance with the task being performed.

Referring now to FIG. 3, additional detail on a decoder 104 is shown. The decoder 104 includes a set of sub-decoders 302. Each sub-decoder receives one or more inputs, represented by the connections 208 to particular sub-encoders 204 of the shared encoder 102. As noted above, these connections 208 are connected or disconnected in accordance with decisions from the policy networks 106, which establish the connections between the sub-encoders 204 and particular sub-decoders 302 in accordance with a detected task.

The outputs of the sub-decoders 302 are combined with a concatenation operation 304, to generate an output 306 for a particular task k. This output may further be combined with a hidden representation of the task k, generated by the task model 120, to generate a final output 124, as discussed above.

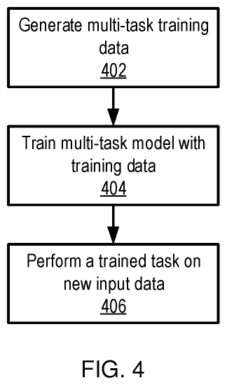

Referring now to FIG. 4, a method of performing training and employing a multi-task model is shown. Block 402 generates a multi-task training data set. This training data may include data from tasks that are related in some way, such as data from fMRI tasks. The tasks, and hence the training data, may include features that share some common parts and some parts that differ from one task to the next. For example, if a first task uses feature types A, B, and C, a second task uses feature types B, C, and D, and a third task uses feature types C, D, and E, the training data may include some or all of these features. Additionally, some features may be entangled with each other, in linear or nonlinear relationships.

Block 404 trains the multi-task model using the multi-task training data set. Both the modular learning model 100 and the task model 120 are trained jointly in an end-to-end fashion. The encoder 102, the decoders 104, and the policy networks 106 of the modular learning model 100 are similarly trained jointly, in an end-to-end fashion.

Block 406 performs a trained task on new input data. For example, classification may be performed for one or more fMRI tasks. The policy networks 106 may detect the task that is being performed, and may automatically configure the connections 206 and 208 to set the model for the detected task.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

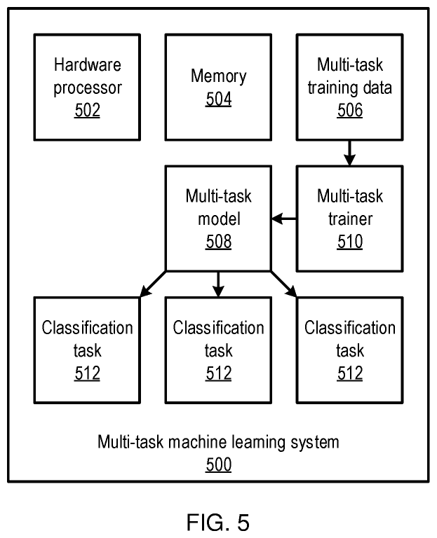

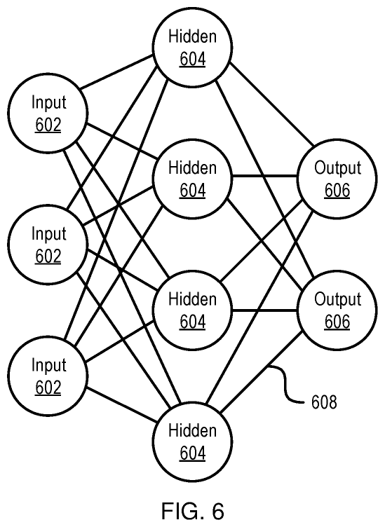

Referring now to FIG. 5, a multi-task machine learning system 500 is shown. The system 500 includes a hardware processor 502 and a memory 504. The system 500 further includes a variety of functional modules. Each of these modules may be implemented as computer program code that is stored in the memory 504 and that is executed by the hardware processor 502 to perform its function. One or more of the functional modules may be implemented as discrete hardware components, for example in the form of application-specific integrated chips or field programmable gate arrays.

A multi-task model 508, such as the one described above in FIG. 1, may be implemented using an artificial neural network (ANN) architecture. The multi-task model 508 may be trained by a multi-task trainer 510 that trains the encoder 102, the decoders 104, and the policy networks 106, using a set of multi-task training data 506. The multi-task training data 506 includes training data that is collected from multiple different tasks 512. These tasks 512 may or may not be related to one another. Although the tasks 512 are shown as being classification tasks, where an input is provided to the multi-task model 508 and the output is one or more labels that describe the input, it should be understood that any appropriate machine learning task may be performed instead.

As noted above, the multi-task model 508 may be implemented as an ANN. An ANN is an information processing system that is inspired by biological nervous systems, such as the brain. The key element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons. An ANN is configured for a specific application, such as pattern recognition or data classification, through such a learning process.

Referring now to FIG. 6, a generalized diagram of a neural network is shown. Although a specific structure of an ANN is shown, having three layers and a set number of fully connected neurons, it should be understood that this is intended solely for the purpose of illustration. In practice, the present embodiments may take any appropriate form, including any number of layers and any pattern or patterns of connections therebetween.

ANNs demonstrate an ability to derive meaning from complicated or imprecise data and can be used to extract patterns and detect trends that are too complex to be detected by humans or other computer-based systems. The structure of a neural network is known generally to have input neurons 602 that provide information to one or more “hidden” neurons 604. Connections 608 between the input neurons 602 and hidden neurons 604 are weighted, and these weighted inputs are then processed by the hidden neurons 604 according to some function in the hidden neurons 604. There can be any number of layers of hidden neurons 604, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. Finally, a set of output neurons 606 accepts and processes weighted input from the last set of hidden neurons 604.

This represents a “feed-forward” computation, where information propagates from input neurons 602 to the output neurons 606. Upon completion of a feed-forward computation, the output is compared to a desired output available from training data. The error relative to the training data is then processed in “backpropagation” computation, where the hidden neurons 604 and input neurons 602 receive information regarding the error propagating backward from the output neurons 606. Once the backward error propagation has been completed, weight updates are performed, with the weighted connections 608 being updated to account for the received error. It should be noted that the three modes of operation, feed forward, back propagation, and weight update, do not overlap with one another. This represents just one variety of ANN computation, and that any appropriate form of computation may be used instead.

To train an ANN, training data can be divided into a training set and a testing set. The training data includes pairs of an input and a known output. During training, the inputs of the training set are fed into the ANN using feed-forward propagation. After each input, the output of the ANN is compared to the respective known output. Discrepancies between the output of the ANN and the known output that is associated with that particular input are used to generate an error value, which may be backpropagated through the ANN, after which the weight values of the ANN may be updated. This process continues until the pairs in the training set are exhausted.

After the training has been completed, the ANN may be tested against the testing set, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, each weight 608 may be characterized as a weight value that is stored in a computer memory, and the activation function of each neuron may be implemented by a computer processor. The weight value may store any appropriate data value, such as a real number, a binary value, or a value selected from a fixed number of possibilities, that is multiplied against the relevant neuron outputs.

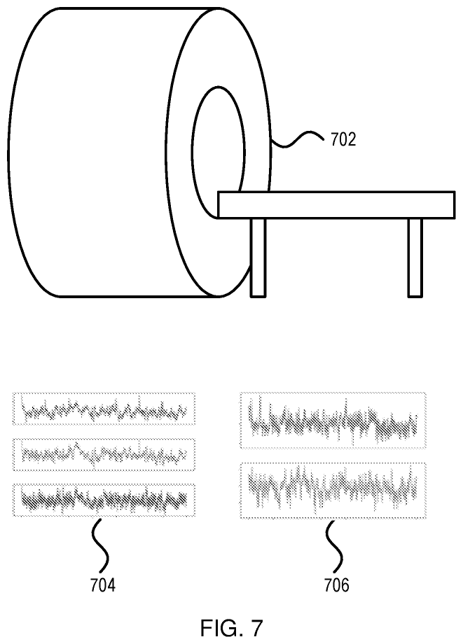

Referring now to FIG. 7, a system that generates data suitable for use in a multitask model is shown. An fMRI device 702 scans the brain of a person, generating fMRI data that relates to various different regions of the brain. This data is similar in many ways, but the different regions of the brain will exhibit different characteristics. Multiple different tasks can be performed using this data, such as classification of a person's health and mental state. For example, fMRI data can be used to detect a seizure, and can provide information regarding a variety of matters of scientific interest. Thus, first data 704 may be relevant to a first task, while second data 706 may be relevant to a second task. These different sets of data can all be used to train a multitask neural network model, as described above.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for training a neural network model, comprising:
training a modular neural network model, which has a shared encoder and one or more task-specific decoders, including training one or more policy networks that control connections between the shared encoder and the one or more task-specific decoders in accordance with multiple tasks; and
training a multitask neural network model for the multiple tasks, with an output of the modular neural network model and the multitask neural network model being combined to form a final output.

2. The method of claim 1, wherein training the modular neural network model includes training a plurality of sub-encoders in the encoder.

3. The method of claim 2, wherein the one or more policy networks further control connections between the sub-encoders in the encoder.

4. The method of claim 2, wherein each of the one or more task-specific decoders includes a plurality of sub-decoders.

5. The method of claim 4, wherein the connections between the shared encoder and the one or more task-specific decoders include a connection between a sub-encoder of the shared encoder and a sub-decoder of one of the one or more task-specific decoders.

6. The method of claim 1, wherein the shared encoder, the one or more task-specific decoders, and the one or more policy networks are jointly trained in an end-to-end fashion.

7. The method of claim 1, wherein the modular neural network model and the task neural network model are jointly trained in an end-to-end fashion.

8. The method of claim 1, wherein the one or more policy networks take a hidden representation output of the multitask neural network model as an input.

9. The method of claim 1, further comprising performing a task using the multitask neural network model and the modular neural network model using input data that includes attributes pertaining to a plurality of the multiple tasks.

10. The method of claim 9, wherein the input data is magnetic resonance imaging data.

11. A system for training a neural network model, comprising:
a hardware processor; and
a memory that stores computer program code, which, when executed by the hardware processor, implements:
a multitask neural network model;
a modular neural network model that has a shared encoder, one or more task-specific decoders, and one or more policy networks that control connections between the shared encoder and the one or more task-specific decoders in accordance with multiple tasks;
a combiner that combines an output of the multitask neural network model to form a final output; and
a model trainer that trains the modular neural network model, including training the one or more policy networks, and that trains the multitask neural network model for the multiple tasks.

12. The system of claim 11, wherein the encoder of the modular neural network model includes a plurality of sub-encoders.

13. The system of claim 12, wherein the one or more policy networks further control connections between the sub-encoders in the encoder.

14. The system of claim 12, wherein each of the one or more task-specific decoders includes a plurality of sub-decoders.

15. The system of claim 14, wherein the connections between the shared encoder and the one or more task-specific decoders include a connection between a sub-encoder of the shared encoder and a sub-decoder of one of the one or more task-specific decoders.

16. The system of claim 11, wherein the model trainer jointly trains the shared encoder, the one or more task-specific decoders, and the one or more policy networks in an end-to-end fashion.

17. The system of claim 11, wherein the model trainer jointly trains the modular neural network model and the task neural network model in an end-to-end fashion.

18. The system of claim 11, wherein the one or more policy networks take a hidden representation output of the multitask neural network model as an input.

19. The system of claim 11, wherein the multitask neural network model performs a task using input data that includes attributes pertaining to a plurality of the multiple tasks.

20. The system of claim 19, wherein the input data is magnetic resonance imaging data.
